(19) United States
(12) Patent Application Publication
(10) Pub. No.: US 2022/0073073 A1
(43) Pub. Date: Mar. 10, 2022

(54) Device and Method for Controlling Platooning

(71) Applicants: Hyundai Motor Company, Seoul (KR); Kia Corporation, Seoul (KR)

(72) Inventor: Jeong Ki Hong, Seongnam-si (KR)

(21) Appl. No.: 17/355,826

(22) Filed: Jun. 23, 2021

(30) Foreign Application Priority Data
Sep. 8, 2020 (KR) 10-2020-0114823

(51) Int. Cl. B60W 30/16; G08G 1/00; G08G 1/0967; H04W 4/46

(52) U.S. Cl. CPC B60W 30/162; G08G 1/22; G08G 1/096791; B60W 2556/65; B60W 2754/30; B60W 2720/10; H04W 4/46

(57) ABSTRACT

A device for controlling platooning includes a communication device configured to support wireless communication between a vehicle and a preceding vehicle, and a processor connected to the communication device, wherein the processor is configured to monitor a communication performance between the vehicle and the preceding vehicle during the platooning and to control a behavior of the vehicle by selectively applying first longitudinal direction control logic or second longitudinal direction control logic based on the communication performance.

### CROSS-REFERENCE TO RELATED APPLICATIONS

This application claims the benefit of Korean Patent Application No. 10-2020-0114823, filed in the Korean Intellectual Property Office on Sep. 8, 2020, which application is hereby incorporated herein by reference.

### TECHNICAL FIELD

The present disclosure relates to a device and a method for controlling platooning.

### BACKGROUND

Platooning is a scheme in which vehicles exchange movement and situation information of a leading vehicle through real-time communication with each other, and thus, travel together while maintaining a certain distance from the leading vehicle. One of the greatest purposes of such platooning is to significantly reduce a vehicle-to-vehicle distance from a preceding vehicle to reduce air resistance of a following vehicle, thereby obtaining an effect of improving fuel economy.

The air resistance received by the following vehicle should be reduced to maximize the fuel economy effect, and the vehicle-to-vehicle distance should be reduced as much as possible to reduce the air resistance. In conventional smart cruise control (SCC) control, a map is set to increase a gain value of a required acceleration to respond well to a behavior of the preceding vehicle for safety as the vehicle-to-vehicle distance from the preceding vehicle is reduced.

Accordingly, when the vehicle-to-vehicle distance from the preceding vehicle is reduced to improve the fuel economy effect, the gain value of the required acceleration increases. When the gain value of the required acceleration is large, the following vehicle reacts sensitively to oscillation of a speed of the preceding vehicle, which occurs because of vehicle control characteristics, and accelerates and brakes frequently, thereby reducing the fuel economy effect.

### SUMMARY

An embodiment of the present disclosure provides a device and a method for controlling platooning that control vehicle responsiveness to a preceding vehicle based on a communication performance between a vehicle and the preceding vehicle during platooning.

The technical problems that can be solved by embodiments of the present inventive concept are not limited to the aforementioned problems, and any other technical problems not mentioned herein will be clearly understood from the following description by those skilled in the art to which the present disclosure pertains.

According to an embodiment of the present disclosure, a device for controlling platooning includes a communication device for supporting wireless communication between a vehicle and a preceding vehicle, and a processor connected to the communication device, wherein the processor monitors a communication performance between the vehicle and the preceding vehicle during the platooning, and controls a behavior of the vehicle by selectively applying first longitudinal direction control logic or second longitudinal direction control logic based on the communication performance.

In one implementation, the processor may count messages received from the preceding vehicle during a predetermined time to calculate a number of received messages, calculate a number of normal messages with no detected error among the received messages, and calculate a communication performance index using the number of received messages and the number of normal messages.

In one implementation, the communication performance index may be a ratio of the number of normal messages to the number of received messages.

In one implementation, the processor may determine fuel economy-specific strategy activation when the communication performance index is equal to or greater than a first reference performance index and less than a second reference performance index.

In one implementation, the processor may adjust a gain map stored in advance based on the first longitudinal direction control logic when the fuel economy-specific strategy activation is determined.

In one implementation, the processor may adjust a vehicle-to-vehicle distance section where a response speed of the vehicle is maintained equal to or below a predetermined reference response speed by applying a first time gap.

In one implementation, the processor may determine a gain value based on a distance between the vehicle and the preceding vehicle based on the adjusted gain map, and control acceleration or deceleration of the vehicle using the determined gain value and a control error.

In one implementation, the processor may determine a fuel economy-specific strategy extended application when the communication performance index is equal to or greater than the second reference performance index.

In one implementation, the processor may extend the vehicle-to-vehicle distance section by applying a second time gap when the fuel economy-specific strategy extended application is determined.

In one implementation, the processor may perform vehicle control based on the second longitudinal direction control logic when the communication performance index is less than the first reference performance index.

According to another embodiment of the present disclosure, a method for controlling platooning includes monitoring a communication performance between a vehicle and a preceding vehicle during the platooning, and controlling a behavior of the vehicle by selectively applying first longitudinal direction control logic or second longitudinal direction control logic based on the communication performance.

In one implementation, the monitoring of the communication performance may include counting messages received from the preceding vehicle during a predetermined time to calculate a number of received messages, calculating a number of normal messages with no detected error among the received messages, and calculating a communication performance index using the number of received messages and the number of normal messages.

In one implementation, the communication performance index may be a ratio of the number of normal messages to the number of received messages.

In one implementation, the controlling of the behavior of the vehicle may include determining whether the communication performance index is equal to or greater than a first reference performance index, and determining a fuel economy-specific strategy activation when the communication performance index is equal to or greater than the first reference performance index.

In one implementation, the controlling of the behavior of the vehicle may further include adjusting a gain map stored in advance based on the first longitudinal direction control logic when the fuel economy-specific strategy activation is determined.

In one implementation, the adjusting of the gain map stored in advance may include adjusting a vehicle-to-vehicle distance section where a response speed of the vehicle is maintained equal to or below a predetermined reference response speed by applying a first time gap.

In one implementation, the controlling of the behavior of the vehicle may further include determining a gain value based on a distance between the vehicle and the preceding vehicle based on the adjusted gain map, and controlling acceleration or deceleration of the vehicle using the determined gain value and a control error.

In one implementation, the controlling of the behavior of the vehicle may further include determining a fuel economy-specific strategy extended application when the communication performance index is equal to or greater than the second reference performance index.

In one implementation, the controlling of the behavior of the vehicle may further include extending the vehicle-to-vehicle distance section by applying a second time gap when the fuel economy-specific strategy extended application is determined.

In one implementation, the controlling of the behavior of the vehicle may further include performing vehicle control based on the second longitudinal direction control logic when the communication performance index is less than the first reference performance index.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a block diagram illustrating a platooning control device according to embodiments of the present disclosure;

FIG. 2 is a diagram for illustrating an operation of a first longitudinal direction control logic according to embodiments of the present disclosure;

FIG. 3 is a diagram for illustrating an operation of a second longitudinal direction control logic according to embodiments of the present disclosure;

FIGS. 4A-4C are graphs illustrating response characteristics based on a communication performance according to embodiments of the present disclosure;

FIG. 5 is a flowchart illustrating a platooning control method according to embodiments of the present disclosure; and

FIG. 6 is a flowchart illustrating a communication performance monitoring method according to embodiments of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of the related known configuration or function will be omitted when it is determined that it interferes with the understanding of the embodiments of the present disclosure.

In describing the components of the embodiments according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Typically, platooning refers to traveling by forming a cluster of one leading vehicle (LV) and one or more following vehicles (FV). In embodiments of the present specification, the leading vehicle (LV) refers to a foremost vehicle of a vehicle line (a platooning line), a following vehicle (FV) refers to a vehicle following the leading vehicle (LV), a tail end vehicle refers to a rearmost vehicle in the platooning line, and a preceding vehicle refers to a vehicle immediately in front of a vehicle (a host vehicle).

Embodiments of the present disclosure control responsiveness (a response speed) of the vehicle to the preceding vehicle in consideration of a communication performance (a status) between the vehicle and the preceding vehicle, which is the vehicle immediately in front of the vehicle during platooning, so that embodiments of the present disclosure relate to a technology of improving a fuel economy effect of the vehicle.

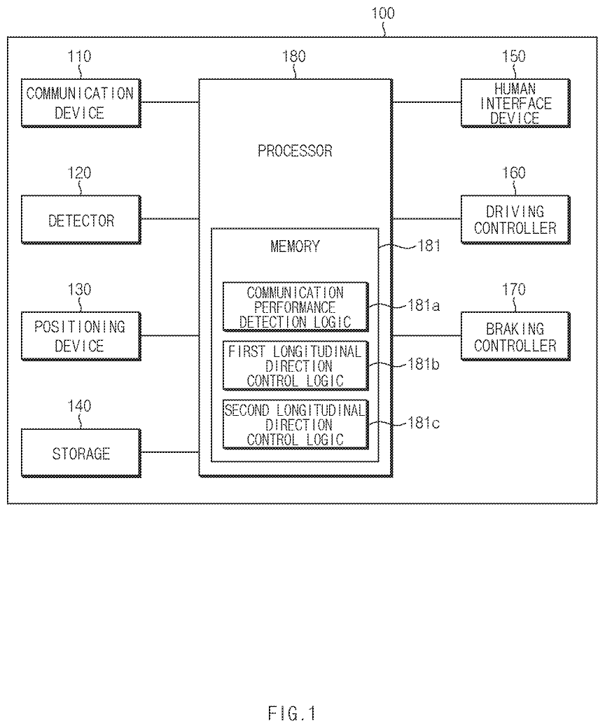

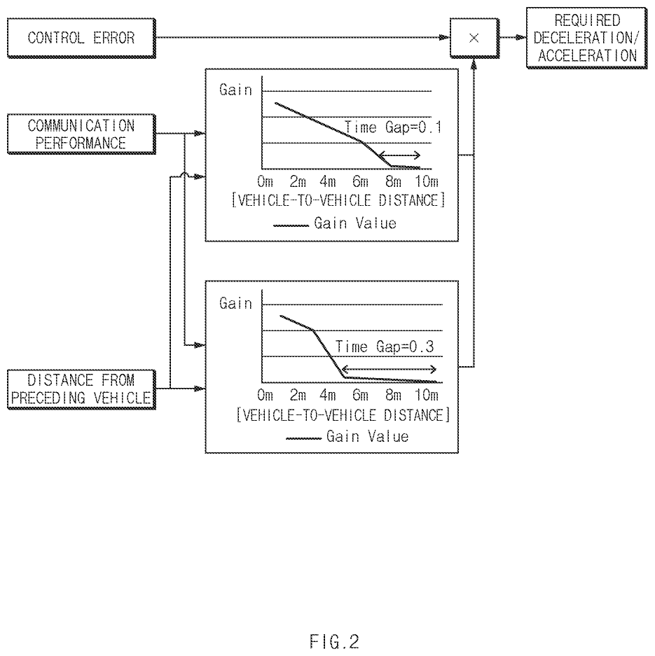

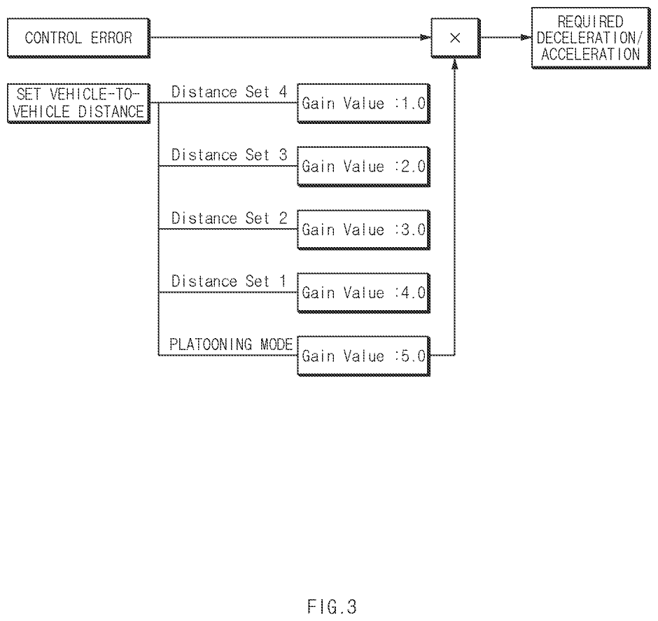

FIG. 1 is a block diagram illustrating a platooning control device according to embodiments of the present disclosure. FIG. 2 is a diagram for illustrating an operation of first longitudinal direction control logic according to embodiments of the present disclosure, and FIG. 3 is a diagram for illustrating an operation of second longitudinal direction control logic according to embodiments of the present disclosure.

A platooning control device 100 is mounted on the vehicle and serves to control a behavior of the vehicle during the platooning. The platooning control device 100 may be implemented as at least one electric control unit (ECU).

Referring to FIG. 1, the platooning control device 100 may include a communication device no, a detector 120, a positioning device 130, storage 140, a human interface device (HID) 150, a driving controller 160, a braking controller 170, and a processor 180.

The communication device no may support wireless communication between the vehicle and an external device (e.g., a platooning control device mounted on another vehicle in the cluster, a mobile terminal or a server, and the like). The communication device no may use vehicle to everything (V2X) communication technologies such as vehicle to vehicle (V2V) communication and/or vehicle to infrastructure (V2I) communication. For example, the communication device no may transmit and receive a V2V communication message. The communication device no may use at least one of communication technologies such as wireless Internet (e.g., Wi-Fi), short-range communication (e.g., Bluetooth, Zigbee, and infrared communication), mobile communication, and/or the like.

The communication device 110 may support the platooning control device 100 to communicate with electric control units (ECUs) in the vehicle connected through an in-vehicle network (IVN). As in-vehicle communication, controller area network (CAN) communication, media oriented systems transport (MOST) communication, local interconnect network (LIN) communication, or X-by-Wire (Flexray) communication may be used. The communication device no may include a communication processor, a communication circuit, an antenna, and/or a transceiver.

The detector 120 may detect the preceding vehicle using sensors mounted on the vehicle and obtain preceding vehicle information. The detector 120 may sense a behavior of the preceding vehicle using at least one sensor such as an advanced driver assistance system (ADAS) sensor, a light detection and ranging (LiDAR), a radio detecting and ranging (RADAR), an image sensor (or a camera), and an ultrasonic sensor. The preceding vehicle information may include a speed, an acceleration, and/or a distance of the preceding vehicle.

The detector 120 may detect behavior information such as a speed and/or an acceleration of the vehicle using the sensors (e.g., a speed sensor, an acceleration sensor, an inertial sensor, and/or the like). The detector 120 may obtain information on a surrounding environment of the vehicle. For example, the detector 120 may obtain weather information and/or road information using a rain sensor, an illuminance sensor, an image sensor, and the like.

The positioning device 130 may measure a current position of the vehicle. The positioning device 130 may measure the vehicle position using at least one of positioning technologies such as a global positioning system (GPS), a dead reckoning (DR), a differential GPS (DGPS), a carrier phase differential GPS (CDGPS), and the like. When using the GPS, the positioning device 130 may calculate the current position of the vehicle (the vehicle position) using triangulation.

The storage 140 may store map information (map data), the preceding vehicle information, and the like. In addition, the storage 140 may store the communication message received through the communication device 110. The storage 140 may be implemented as at least one of storage media (recording media) such as a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, web storage, and the like.

The human interface device 150 may generate data resulted from manipulation of a user or output a progress status and/or a result resulted from an operation of the processor 180. The human interface device 150 may include input devices such as a button, a switch, a touch pad, and/or a touch screen, displays (e.g., a cluster, an audio video navigation (AVN), a touch screen, or a head-up display (HUD)), and output devices such as a speaker and/or a vibrator. The input devices are placed on a steering wheel, a dashboard, a center fascia, and/or a door trim.

The human interface device 150 may generate data that turns on or off a platooning function in response to a user input. In addition, the human interface device 150 may generate data for setting a distance between the vehicle and the preceding vehicle, that is, a vehicle-to-vehicle distance in response to the manipulation of the user. In addition, the human interface device 150 may output visual information, auditory information, and/or tactile information in response to instruction of the processor 180. For example, the human interface device 150 may output the start, end, and the like of the platooning on the display.

The driving controller 160 controls driving of the vehicle, which may transmit power generated from a power source (e.g., an engine or a motor) to a wheel. The driving controller 160 may be implemented as a traction control system (TCS) and/or an all wheel drive system (AWD).

The braking controller 170 may decelerate or stop the vehicle. The braking controller 170 may include an anti-lock braking system (ABS), an electronic stability control (ESC), and/or an electronic parking brake (EPB) system.

The driving controller 160 and the braking controller 170 described above each may include a communication circuit, a processor, a memory, and the like (not shown).

The processor 180 may control overall operations of the platooning control device 100. The processor 180 may include at least one of an application specific integrated circuit (ASIC), a digital signal processor (DSP), a programmable logic device (PLD), a field programmable gate array (FPGA), a central processing unit (CPU), a microcontroller, and a microprocessor. The processor 180 may include a memory 181. The memory 181 may be implemented as a non-transitory storage medium that stores instructions executed by the processor 180. The memory 181 may include a ROM, a RAM, a flash memory, a PROM, a SRAM, an EPROM, an EEPROM, and/or a register. The memory 181 may store communication performance detection logic 181a, first longitudinal direction control logic 181b, second longitudinal direction control logic 181c, and the like. The first longitudinal direction control logic 181b allows longitudinal direction control to be performed by applying a strategy for improving the fuel economy effect (a fuel economy specific strategy). The second longitudinal direction control logic 181c allows the longitudinal direction control to be performed based on a preset target vehicle-to-vehicle distance like an existing smart cruise control (SCC) device.

In the present embodiment, one processor 180 that executes the communication performance detection logic 181a, the first longitudinal direction control logic 181b, and the second longitudinal direction control logic 181c is described as an example, but separate processors 180 that respectively implement the logics may be implemented.

The processor 180 may monitor the communication performance between the vehicle and the preceding vehicle using the communication performance detection logic 181a. The processor 180 may receive the message (e.g., the V2V communication message) transmitted from the preceding vehicle through the communication device 110. The processor 180 may count the messages received from the preceding vehicle during a predetermined time (e.g., 20 ms). The processor 180 may determine whether the number of received messages is updated when the predetermined time elapses. For example, in a case of accumulating and counting the number of received messages, the processor 180 may recognize that the number of received messages is updated when the number of received messages currently counted is greater than the number of received messages counted previously. In the present embodiment, the message received from the preceding vehicle is counted based on the communication performance detection logic 181a as an example, but the present disclosure is not limited thereto. The communication device 110 may be implemented to count the message received from the preceding vehicle using a message counter.

The processor 180 may determine a status of the received message by identifying contents of the received message. The processor 180 may identify the contents of the received message using an error detection scheme such as a checksum and the like. The processor 180 may determine the status of the received message (e.g., normal or error) based on the result of identifying the contents. For example, when an error is not detected in the received message, the processor 180 may determine the status of the received message as the normal. When the error is detected in the received message, the processor 180 may determine the status of the received message as the error. The processor 180 may identify the statuses of the received messages to count the number of normal messages (proper received messages) among the received messages. In other words, the processor 180 may count the number of normal messages from which the error is not detected among the messages received from the preceding vehicle.

When the message is not received until the predetermined time elapses, the processor 180 may consider that the message error has occurred. For example, when the message counter is not updated, the processor 180 may consider that the message error has occurred. When there is no message received from the preceding vehicle for the predetermined time, the processor 180 may consider that the error has occurred and count the number of message errors (the error detection number). In addition, the processor 180 may count the number of message errors when the error is detected in the received message. In this connection, the processor 180 may count message errors that are consecutively generated to calculate the number of consecutive message errors.

The processor 180 may calculate a communication performance index (indicator) using the number of received messages and the number of normal messages. For example, the processor 180 may calculate a ratio of the normal messages to the received messages, that is, a packet receive rate (PRR). In the present embodiment, use of the PRR as the indicator for evaluating the communication performance is described as an example, but the present disclosure is not limited thereto. The PRR may be replaced with another factor used as the communication performance indicator.

The processor 180 may determine activation of a fuel economy-specific strategy when the communication performance index is equal to or greater than a first reference performance index. For example, when the PRR is equal to or higher than₉₀%, the processor 180 may determine the activation of the fuel economy-specific strategy. The processor 180 may control a longitudinal direction behavior of the vehicle by executing the first longitudinal direction control logic 181b, when the activation of the fuel economy-specific strategy is determined. The first longitudinal direction control logic 181b may adjust a gain map previously stored in the memory 181. In the gain map, a gain value (a responsive gain or a required deceleration/acceleration gain) based on the distance between the vehicle and the preceding vehicle (the vehicle-to-vehicle distance) may be defined. The first longitudinal direction control logic 181b may adjust (transform) the gain map by applying a predetermined first time gap. In other words, the first longitudinal direction control logic 181b may adjust a vehicle-to-vehicle distance section that maintains the gain value equal to or below a preset gain value (e.g., 0.2) based on the first time gap (e.g., 0.1). In this case, the vehicle-to-vehicle distance section may be determined based on a target vehicle-to-vehicle distance.

When the communication performance index is equal to or greater than a second reference performance index, the processor 180 may determine extended application of the fuel economy-specific strategy. In this connection, the second reference performance index may be set greater than the first reference performance index. For example, when the PRR is equal to or higher than 99%, the processor 180 may determine the extended application of the fuel economy-specific strategy. When the extended application of the fuel economy-specific strategy is determined, the processor 180 may adjust the gain map by applying a predetermined second time gap (e.g., 0.3) using the first longitudinal direction control logic 181b. The first time gap and the second time gap refer to ratios of a vehicle-to-vehicle distance range (a section) that lowers the gain value to be equal to or less than a preset gain value (e.g. 0.2) compared to the target vehicle-to-vehicle distance, which may be different from each other.

Referring to FIG. 2, when the communication performance is good, that is, when the PRR is equal to or higher than 90% and less than 99%, the processor 180 may slow a response speed of the vehicle by lowering the gain value by the time gap of 0.1. In other words, when the target vehicle-to-vehicle distance is set to 10 m, the processor 180 may maintain the gain value (e.g., 0.2) low until the distance between the preceding vehicle and the vehicle becomes 8 m. In addition, when the communication performance is very good, that is, when the PRR is equal to or higher than 99%, the processor 180 may slow the response speed of the vehicle by lowering the gain value by the time gap of 0.3. For example, when the target vehicle-to-vehicle distance is 10 m, the processor 180 may lower the gain value (e.g., 0.2) until the distance between the preceding vehicle and the vehicle becomes 4 m, thereby slowing the response speed of the vehicle. The processor 180 may determine the gain value based on the vehicle-to-vehicle distance between the preceding vehicle and the vehicle by referring to the gain map adjusted based on the first time gap or the second time gap, and calculate a required deceleration/acceleration by multiplying the determined gain value and a control error.

When the communication performance index is less than the first reference performance index or the number of consecutive message errors is equal to or greater than a predetermined reference number, the processor 180 may determine fuel economy-specific strategy off. When the fuel economy-specific strategy off is determined, the processor 180 may control the behavior of the vehicle by executing the second longitudinal direction control logic 181c. The processor 180 may calculate the required deceleration/acceleration based on the control error of the vehicle and a gain value based on vehicle-to-vehicle distance setting (that is, the target vehicle-to-vehicle distance). The processor 180 may determine the gain value based on the vehicle-to-vehicle distance setting by referring to the gain map previously stored in the memory 181.

The processor 180 may calculate a required deceleration/acceleration proportional integral derivative (PID) control amount using a following [Equation 1].

Required deceleration/acceleration PID control amount=(P gain value×speed error)+(I gain value×distance error)+(D gain value×acceleration error) Equation 1

In this connection, gain values of respective terms of P control, I control, and D control are subjected to different map settings, but have the same tendency in a change of responsiveness resulted from increase and decrease of the gain values, so that the P control, the I control, and the D control may be expressed by being integrated into one control error and one gain value. An actual gain map is set to different values depending on a vehicle speed. However, in the present embodiment, the actual gain map may be expressed as a constant because a situation in which the vehicle travels at a constant speed is premised. The smaller the vehicle-to-vehicle distance, the higher the gain value multiplied by the control error and the higher the required acceleration based on the error, so that the response speed may become fast.

For example, referring to FIG. 3, when the vehicle-to-vehicle distance is set to a ‘platooning mode’, the processor 180 may set the vehicle-to-vehicle distance to 10 m based on the second longitudinal direction control logic 181c and set the gain value to 5.0 within the vehicle-to-vehicle distance 10 m to calculate the required deceleration/acceleration.

The processor 180 may perform vehicle control based on the calculated required deceleration/acceleration. The processor 180 may accelerate or decelerate (brake) the vehicle by controlling the driving controller 160 or the braking controller 170 based on the required deceleration/acceleration.

According to the embodiment described above, when the communication performance between the vehicle and the preceding vehicle is equal to or above a certain level, the responsiveness (the response speed) of the vehicle to the preceding vehicle may be desensitized to improve the fuel economy.

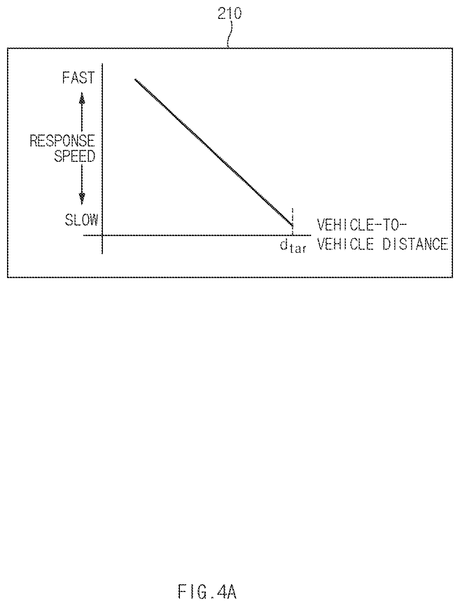

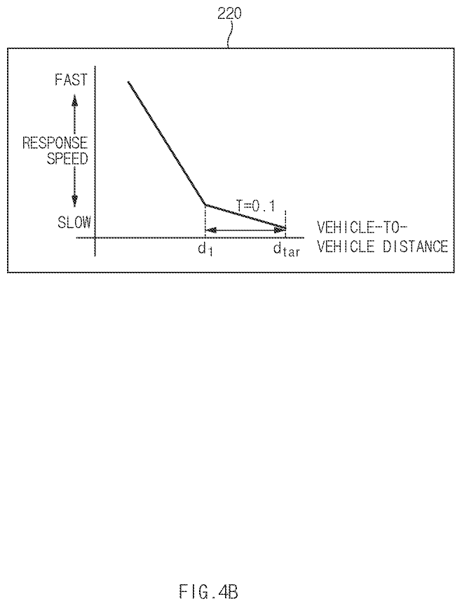

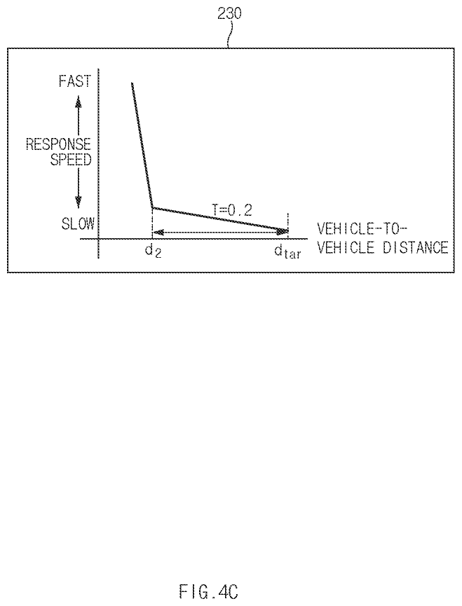

FIGS. 4A-4C are graphs illustrating response characteristics based on a communication performance according to embodiments of the present disclosure.

When the communication performance is less than a first reference performance, referring to a response speed graph 210 based on the vehicle-to-vehicle distance in FIG. 4A, the processor 180 may control the response speed of the vehicle to increase as the distance between the vehicle and the preceding vehicle becomes smaller than a target vehicle-to-vehicle distance dₜₐᵣ.

When the communication performance is equal to or above the first reference performance and less than a second reference performance, referring to a response speed graph 220 based on the vehicle-to-vehicle distance in FIG. 4B, when the distance between the vehicle and the preceding vehicle is within a section between d₁ and the target vehicle-to-vehicle distance dₜₐᵣ, the processor 180 may adjust the response speed to be equal to or less than a specific response speed. When the vehicle-to-vehicle distance is within the section between d₁ and dₜₐᵣ, the processor 180 may slow the response speed of the vehicle to the preceding vehicle to improve the fuel economy effect.

When the communication performance is equal to or greater than the second reference performance, referring to a response speed graph 230 based on the vehicle-to-vehicle distance in FIG. 4C, when the distance between the vehicle and the preceding vehicle is within a section between d₂ and the target vehicle-to-vehicle distance, the processor 180 may control the response speed of the vehicle to the preceding vehicle to be equal to or less than the specific response speed.

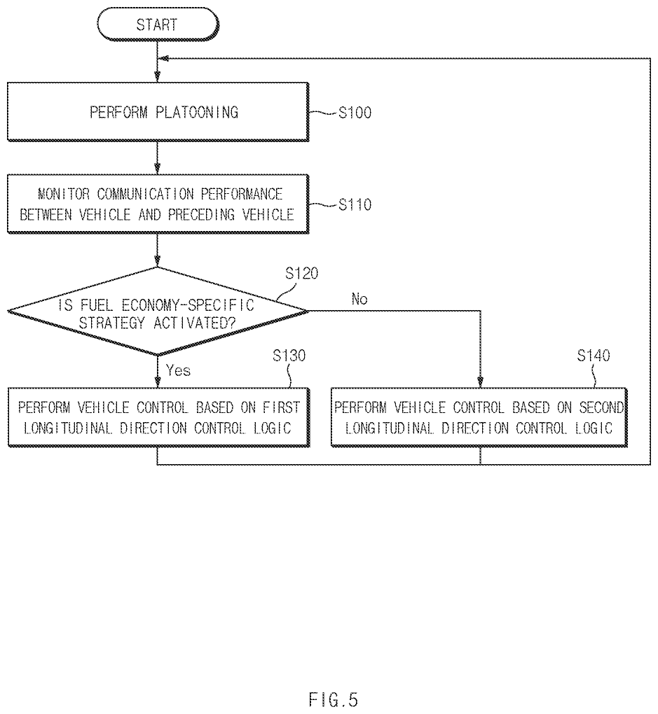

FIG. 5 is a flowchart illustrating a platooning control method according to embodiments of the present disclosure.

The processor 180 may perform the platooning when the vehicle forms the cluster with at least one other vehicle (S100). The vehicle may continuously communicate with the vehicle immediately in front of the vehicle in the cluster, that is, the preceding vehicle, to transmit and receive information to and from the preceding vehicle.

The processor 180 may monitor the communication performance between the vehicle and the preceding vehicle (S110). The processor 180 may identify the communication performance using the communication performance detection logic 181a.

The processor 180 may determine the fuel economy-specific strategy activation based on the communication performance (S120). The processor 180 may determine the fuel economy-specific strategy activation when the communication performance is equal to or greater than a predetermined reference performance.

When the fuel economy-specific strategy activation is determined, the processor 180 may perform the vehicle control based on the first longitudinal direction control logic 181b (S130). The processor 180 may adjust the gain map previously stored in the memory 181 based on the first longitudinal direction control logic 181b. In other words, the processor 180 may adjust the vehicle-to-vehicle distance section (the time gap) that maintains the response speed of the vehicle equal to or below a predetermined reference speed. The processor 180 may determine the gain value based on the distance between the vehicle and the preceding vehicle by referring to the adjusted gain map, and calculate the required deceleration/acceleration based on the determined gain value and the control error. The processor 180 may accelerate or decelerate the vehicle by controlling the driving controller 160 or the braking controller 170 based on the calculated required deceleration/acceleration.

When the fuel economy-specific strategy activation is not determined, the processor 180 may perform the vehicle control using the second longitudinal direction control logic 181c (S140). The processor 180 may determine the gain value based on the target vehicle-to-vehicle distance by referring to the gain map previously stored in the memory 181 based on the second longitudinal direction control logic 181c, and calculate the required deceleration/acceleration based on the determined gain value and the control error. The processor 180 may accelerate or decelerate the vehicle by controlling the driving controller 160 or the braking controller 170 based on the calculated required deceleration/acceleration.

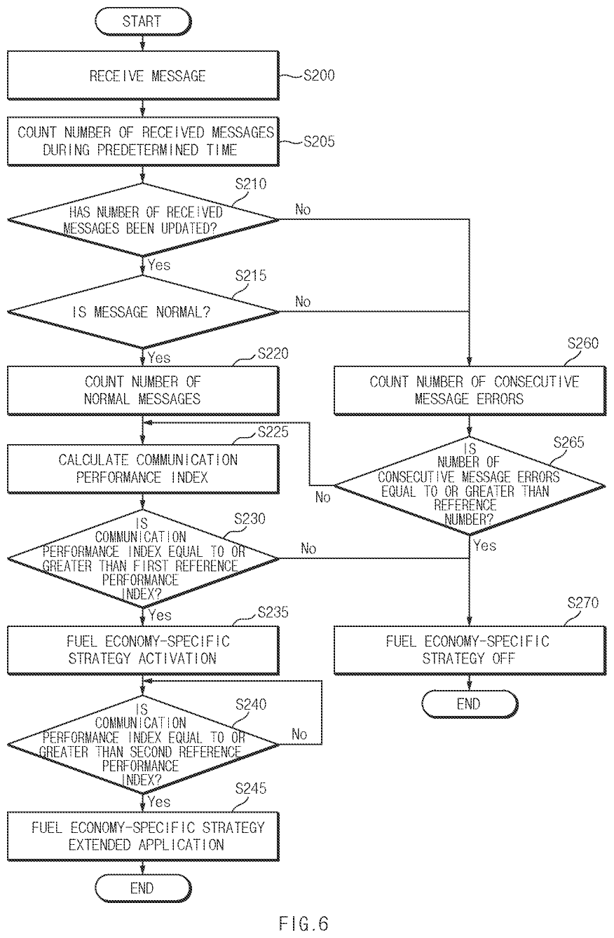

FIG. 6 is a flowchart illustrating a communication performance monitoring method according to embodiments of the present disclosure.

The processor 180 may receive the message transmitted from the preceding vehicle using the communication device 110 (S200). For example, the processor 180 may receive the communication message transmitted from the preceding vehicle using the V2V communication.

The processor 180 may count the number of received messages during the predetermined time (S205). The processor 180 may increase the number of received messages by +1 each time the communication message transmitted from the preceding vehicle is received for the predetermined time.

The processor 180 may determine whether the number of received messages has been updated (S210). When there is a change in the number of received messages, the processor 180 may determine that the update has been performed. Further, when there is no change in the number of received messages, the processor 180 may determine that the update has not been performed. For example, when the message is not received until the predetermined time elapses, the processor 180 may determine that the number of received messages has not been updated.

When the number of received messages is updated, the processor 180 may determine whether the received message is normal (S215). The processor 180 may detect the error in the received message by identifying the contents of the received message using the known error detection scheme (e.g., the checksum). When the error is not detected in the received message, the processor 180 may determine the status of the received message as the normal. When the error is detected in the received message, the processor 180 may determine the status of the received message as the error.

When the received message is normal, the processor 180 may count the number of normal messages (S220). The processor 180 may count the number of received messages from which the error is not detected.

The processor 180 may calculate the communication performance index based on the number of received messages and the number of normal messages (S225). The PRR may be used as the communication performance index (indicator). The PRR means the ratio of the number of the normal messages to the number of the received messages.

The processor 180 may determine whether the communication performance index is equal to or greater than the first reference performance index (S230).

When the communication performance index is equal to or greater than the first reference performance index, the processor 180 may determine the fuel economy-specific strategy activation (S235). For example, the processor 180 may determine the fuel economy-specific strategy activation when the PRR is equal to or higher than 90%.

The processor 180 may determine whether the communication performance index is equal to or greater than the second reference performance index (S240). The second reference performance index may be set higher than the first reference performance index.

When the communication performance index is equal to or greater than the second reference performance index, the processor 180 may determine the fuel economy-specific strategy extended application (S245). For example, the processor 180 may determine the fuel economy-specific strategy extended application when the PRR is equal to or higher than 99%.

When the number of received messages is not updated in S210 or the message error is detected in S215, the processor 180 may count the number of consecutive message errors (S260). The processor 180 may count the message errors that consecutively occurred.

The processor 180 may determine whether the number of consecutive message errors is equal to or greater than the reference number (S265).

When the number of consecutive message errors is equal to or greater than the reference number, the processor 180 may determine the fuel economy-specific strategy off (S270).

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to embodiments of the present disclosure, the vehicle responsiveness to the preceding vehicle is controlled based on the communication performance between the vehicle and the preceding vehicle during the platooning to reduce unnecessary acceleration and deceleration, thereby improving a fuel efficiency of the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling platooning, the device comprising:
a communication device configured to support wireless communication between a vehicle and a preceding vehicle; and
a processor connected to the communication device, wherein the processor is configured to:
monitor a communication performance between the vehicle and the preceding vehicle during the platooning; and
control a behavior of the vehicle by selectively applying first longitudinal direction control logic or second longitudinal direction control logic based on the communication performance.

2. The device of claim 1, wherein the processor is configured to:
count messages received from the preceding vehicle during a predetermined time to calculate a number of received messages;
calculate a number of normal messages with no detected error among the received messages; and
calculate a communication performance index using the number of received messages and the number of normal messages.

3. The device of claim 2, wherein the communication performance index is a ratio of the number of normal messages to the number of received messages.

4. The device of claim 2, wherein the processor is configured to determine a fuel economy-specific strategy activation when the communication performance index is equal to or greater than a first reference performance index and less than a second reference performance index.

5. The device of claim 4, wherein the processor is configured to adjust a gain map stored in advance based on the first longitudinal direction control logic when the fuel economy-specific strategy activation is determined.

6. The device of claim 5, wherein the processor is configured to adjust a vehicle-to-vehicle distance section where a response speed of the vehicle is maintained equal to or below a predetermined reference response speed by applying a first time gap.

7. The device of claim 5, wherein the processor is configured to:
determine a gain value based on a distance between the vehicle and the preceding vehicle based on the adjusted gain map; and
control acceleration or deceleration of the vehicle using the determined gain value and a control error.

8. The device of claim 4, wherein the processor is configured to determine a fuel economy-specific strategy extended application when the communication performance index is equal to or greater than the second reference performance index.

9. The device of claim 8, wherein the processor is configured to extend a vehicle-to-vehicle distance section by applying a second time gap when the fuel economy-specific strategy extended application is determined.

10. The device of claim 4, wherein the processor is configured to perform vehicle control based on the second longitudinal direction control logic when the communication performance index is less than the first reference performance index.

11. A method for controlling platooning, the method comprising:
monitoring a communication performance between a vehicle and a preceding vehicle during the platooning; and
controlling a behavior of the vehicle by selectively applying first longitudinal direction control logic or second longitudinal direction control logic based on the communication performance.

12. The method of claim 11, wherein monitoring the communication performance comprises:
counting messages received from the preceding vehicle during a predetermined time to calculate a number of received messages;
calculating a number of normal messages with no detected error among the received messages; and
calculating a communication performance index using the number of received messages and the number of normal messages.

13. The method of claim 12, wherein the communication performance index is a ratio of the number of normal messages to the number of received messages.

14. The method of claim 12, wherein controlling the behavior of the vehicle comprises:
determining whether the communication performance index is equal to or greater than a first reference performance index; and
determining a fuel economy-specific strategy activation when the communication performance index is equal to or greater than the first reference performance index.

15. The method of claim 14, wherein controlling the behavior of the vehicle further comprises:
adjusting a gain map stored in advance based on the first longitudinal direction control logic when the fuel economy-specific strategy activation is determined.

16. The method of claim 15, wherein adjusting the gain map stored in advance comprises:
adjusting a vehicle-to-vehicle distance section where a response speed of the vehicle is maintained equal to or below a predetermined reference response speed by applying a first time gap.

17. The method of claim 15, wherein controlling the behavior of the vehicle further comprises:
determining a gain value based on a distance between the vehicle and the preceding vehicle based on the adjusted gain map; and
controlling acceleration or deceleration of the vehicle using the determined gain value and a control error.

18. The method of claim 15, wherein controlling the behavior of the vehicle further comprises:
determining a fuel economy-specific strategy extended application when the communication performance index is equal to or greater than a second reference performance index.

19. The method of claim 18, wherein controlling the behavior of the vehicle further comprises:
extending a vehicle-to-vehicle distance section by applying a second time gap when the fuel economy-specific strategy extended application is determined.

20. The method of claim 14, wherein controlling the behavior of the vehicle further comprises:
performing vehicle control based on the second longitudinal direction control logic when the communication performance index is less than the first reference performance index.
